(19) United States
(12) Patent Application Publication
(10) Pub. No.: US 2015/0052155 A1
(43) Pub. Date: Feb. 19, 2015

(54) METHOD AND SYSTEM FOR RANKING MULTIMEDIA CONTENT ELEMENTS

(71) Applicant: Cortica, Ltd., RAMAT GAN (IL)

(72) Inventors: Igal Raichelgauz, New York, NY (US); Karina Odinaev, New York, NY (US); Yehoshua Y. Zeevi, Haifa (IL)

(73) Assignee: Cortica, Ltd., RAMAT GAN (IL)

(21) Appl. No.: 14/530,922

(22) Filed: Nov. 3, 2014

Related U.S. Application Data
(63) Continuation-in-part of application No. 14/050,991, filed on Oct. 10, 2013.
Application No. 14/050,991 is a continuation-in-part of application No. 13/602,858, filed on Sep. 4, 2012, now Pat. No. 8,868,619.
Application No. 13/602,858 is a continuation of application No. 12/603,123, filed on Oct. 21, 2009, now Pat. No. 8,266,185.
Application No. 12/603,123 is a continuation-in-part of application No. 12/084,150, filed on Apr. 7, 2009, now Pat. No. 8,655,801.
Application No. 12/603,123 is a continuation-in-part of application No. 12/348,888, filed on Jan. 5, 2009.
Application No. 12/348,888 is a continuation-in-part of application No. 12/084,150, filed on Apr. 7, 2009, now Pat. No. 8,655,801.
Application No. 12/084,150 is a continuation-in-part of application No. 12/195,863, filed on Aug. 21, 2008, now Pat. No. 8,326,775.
Application No. 12/603,123 is a continuation-in-part of application No. 12/538,495, filed on Aug. 10, 2009, now Pat. No. 8,312,031.
Application No. 12/538,495 is a continuation-in-part of application No. 12/084,150, filed on Apr. 7, 2009, now Pat. No. 8,655,801.
Application No. 12/084,150 is a continuation-in-part of application No. 12/348,888, filed on Jan. 5, 2009.
Application No. 12/603,123 is a continuation-in-part of application No. 12/195,863, filed on Aug. 21, 2008, now Pat. No. 8,326,775.
Application No. 12/195,863 is a continuation-in-part of application No. 12/084,150, filed on Apr. 7, 2009, now Pat. No. 8,655,801.
(60) Provisional application No. 61/899,226, filed on Nov. 3, 2013.

(51) Int. Cl. G06F 17/30

(52) U.S. Cl. CPC G06F 17/3053; G06F 17/30038
USPC 707/749

(57) ABSTRACT

A method and system for ranking and providing at least one multimedia content element respective of a query are disclosed. The method includes receiving at least one query from a user device; generating a matching score for each tagged multimedia content element stored in a data warehouse respective of a match level to the at least one query; ranking each multimedia content element based on its respective matching score; and returning at least one multimedia content element to the user device respective of the ranking.

### CROSS-REFERENCE TO RELATED APPLICATIONS

This application claims the benefit of U.S. provisional application 61/899,226 filed on Nov. 3, 2013. This application is a continuation-in-part (CIP) of U.S. patent application Ser. No. 14/050,991 filed on Oct. 10, 2013, now pending. The Ser. No. 14/050,991 application is a continuation-in-part (CIP) of U.S. patent application Ser. No. 13/602,858 filed Sep. 4, 2012, now U.S. Pat. No. 8,868,619, which is a continuation of U.S. patent application Ser. No. 12/603,123, filed on Oct. 21, 2009, now U.S. Pat. No. 8,266,185, which is a CIP of:
(1) U.S. patent application Ser. No. 12/084,150 having a filing date of Apr. 7, 2009, now U.S. Pat. No. 8,655,801, which is the National Stage of International Application No. PCT/IL2006/001235, filed on Oct. 26, 2006, which claims foreign priority from Israeli Application No. 171577 filed on Oct. 26, 2005 and Israeli Application No. 173409 filed on Jan. 29, 2006;
(2) U.S. patent application Ser. No. 12/195,863, filed Aug. 21, 2008, now U.S. Pat. No. 8,326,775, which claims priority under 35 USC 119 from Israeli Application No. 185414, filed on Aug. 21, 2007, and which is also a continuation-in-part of the above-referenced U.S. patent application Ser. No. 12/084,150;
(3) U.S. patent application Ser. No. 12/348,888, filed Jan. 5, 2009, now pending, which is a CIP of the above-referenced U.S. patent application Ser. No. 12/084,150 and the above-referenced U.S. patent application Ser. No. 12/195,863; and
(4) U.S. patent application Ser. No. 12/538,495 filed Aug. 10, 2009, now U.S. Pat. No. 8,312,031, which is a CIP of US Patent Application No. of the above-referenced U.S. patent application Ser. No. 12/084,150, the above-referenced U.S. patent application Ser. No. 12/195,863, and the above-referenced U.S. patent application Ser. No. 12/348,888.
All of the applications referenced above are herein incorporated by reference for all that they contain.

### TECHNICAL FIELD

The present invention relates generally to the analysis of multimedia content, and more specifically to a system for ranking multimedia content elements based on the analysis.

### BACKGROUND

Search engines are used for searching for information over the World Wide Web. Search engines are also utilized to search locally over the user device. A search query refers to a query that a user enters into such a search engine in order to receive search results. The search query may be in a form of a textual query, an image, or an audio query.

Searching for multimedia content elements (e.g., picture, video clips, audio clips, etc.) stored locally on the user device as well as on the web may not be an easy task. According to the prior art solutions, respective of an input query a search is performed through the metadata of the available multimedia content elements. The metadata is typically associated with a multimedia content element and includes parameters, such as the element's size, type, name, a short description, and so on. The description and name of the element are typically provided by the creator of the element and by a person saving or placing the element in a local device and/or a website. Therefore, metadata of an element, in most cases, is not sufficiently descriptive of the multimedia element. For example, a user may save a picture of a cat under the file name of “weekend fun”, thus the metadata would not be descriptive of the contents of the picture.

As a result, searching for multimedia content elements based solely on their metadata may not provide the most accurate results. Following the above example, the input query ‘cat’ would not return the picture saved under “weekend fun”.

In cases where advertisers search for certain content in order to leave a certain impression on users, the task of finding the appropriate content is even more complicated as allegedly similar content items may leave a very different impression.

In computer science, a tag is a non-hierarchical keyword or term assigned to a piece of information, such as multimedia content elements. Tagging has gained wide popularity due to the growth of social networking, photograph sharing, and bookmarking of websites. Some websites allow users to create and manage tags that categorize content using simple keywords. The users of such sites manually add and define the description of the tags. However, some websites limit the tagging options of multimedia elements, for example, by only allowing tagging of people shown in a picture. Therefore, searching for all multimedia content elements solely based on the tags would not be efficient.

It would be therefore advantageous to provide a solution that overcomes the deficiencies of the prior art by providing search results respective of the contents of the multimedia elements. It should be further advantageous if the provided content is ranked based on each item match to the search query.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later. For convenience, the term “some embodiments” may be used herein to refer to a single embodiment or multiple embodiments of the disclosure.

The various disclosed embodiments include a method for ranking and providing at least one multimedia content element respective of a query. The method comprises receiving at least one query from a user device; generating a matching score for each tagged multimedia content element stored in a data warehouse respective of a match level to the at least one query; ranking each multimedia content element based on its respective matching score; and returning at least one multimedia content element to the user device respective of the ranking.

The various disclosed embodiments also include a system for ranking and providing one or more multimedia content elements respective of a query. The system comprises a processing system; a memory connected to the processing system, the memory containing instructions that when executed by the processing system, configure the system to: receive at least one query from a user device; generate a matching score for each tagged multimedia content element stored in a data warehouse respective of a match level to the at least one query; rank each multimedia content element based its respective matching score; and return at least one multimedia content element to the user device respective of the ranking.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a schematic block diagram of a network system utilized to describe the various embodiments disclosed herein.

FIG. 2 is a flowchart describing the process of identifying multimedia content elements collected by a user device.

FIG. 3 is a flowchart describing the process of enhancing a user search experience through a user device according to an embodiment.

FIG. 4 is a block diagram depicting the basic flow of information in the signature generator system.

FIG. 5 is a diagram showing the flow of patches generation, response vector generation, and signature generation in a large-scale speech-to-text system.

FIG. 6 is a flowchart describing the process of ranking multimedia content element respective of a match to a query received from a user device according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views.

The certain disclosed embodiments provide a system and a method for enhancing and enriching users' experience while navigating through multimedia content elements stored in a data warehouse. In an embodiment, the system receives at least one search query from a user of a user device. The system analyzes the multimedia content elements existing in the data warehouse and generates one or more signatures respective thereto. Based on the generated signatures at least one tag is provided which includes descriptive information about the contents of the multimedia elements. The system then generates a matching score for each tagged multimedia content element stored in a data warehouse respective of a match level to the at least one query. Each multimedia content element based is ranked respective matching score and at least one multimedia content element is returned to the user device respective of the ranking.

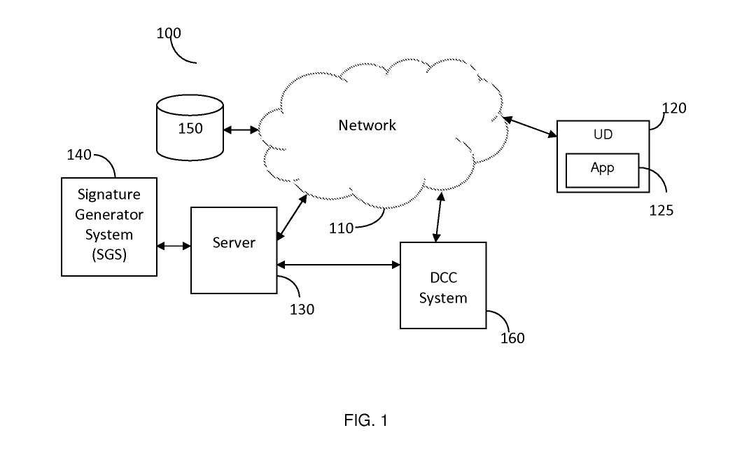

FIG. 1 shows an exemplary and non-limiting schematic diagram of a network system 100 utilized to describe the various embodiments disclosed herein. A network 110 is used to communicate between different parts of the system 100. The network 110 may be the Internet, the world-wide-web (WWW), a local area network (LAN), a wide area network (WAN), a metro area network (MAN), and other networks capable of enabling communication between the elements of the system 100.

Further connected to the network 110 is a user device 120. A user device 120 may be, for example, a personal computer (PC), a personal digital assistant (PDA), a mobile phone, a smart phone, a tablet computer, an electronic wearable device (e.g., glasses, a watch, etc.), and other kinds of wired and mobile appliances, equipped with browsing, viewing, capturing, storing, listening, filtering, and managing capabilities enabled as further discussed herein below.

The user device 120 may further include a software application (App) 125 installed thereon. A software application App 125 may be downloaded from an application repository, such as the AppStore®, Google Play®, or any repositories hosting software applications. The application 125 may be pre-installed in the user device 120. In one embodiment, the application 125 is a web-browser. It should be noted that only one user device 120 and one application 125 are discussed with reference to FIG. 1 merely for the sake of simplicity. However, the embodiments disclosed herein are applicable to a plurality of user devices that can access the server 130 and multiple applications installed thereon.

Also communicatively connected to the network 110 is a data warehouse 150 that stores multimedia content elements, tags related to the multimedia content elements, and so on. In the embodiment illustrated in FIG. 1, a server 130 communicatively communicates with the data warehouse 150 through the network 110. In other non-limiting configurations, the server 130 is directly connected to the data warehouse 150.

The system 100 shown in FIG. 1 includes a signature generator system (SGS) 140 and a deep-content classification (DCC) system 160 which are utilized by the server 130 to perform the various disclosed embodiments. The SGS 140 and the DCC system 160 may be connected to the server 130 directly or through the network 110. In certain configurations, the DCC system 160 and the SGS 140 may be embedded in the server 130.

It should be noted that the server 130 typically comprises a processing system (not shown), a memory (not shown), and optionally a network interface (not shown). The processing system is connected to the memory, which is configured to contain instructions that can be executed by the processing system. The server 130 may also include a network interface (not shown) to the network 110. In one embodiment, the processing system is realized or includes an array of computational cores configured as discussed in more detail below. In another embodiment, the processing system of each of the server 130 and SGS 140 may comprise or be a component of a larger processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The server 130 is configured to receive and serve multimedia content elements. A multimedia content element may include, for example, an image, a graphic, a video stream, a video clip, an audio stream, an audio clip, a video frame, a photograph, and an image of signals (e.g., spectrograms, phasograms, scalograms, etc.), and/or combinations thereof and portions thereof. The operation of serving multimedia content elements includes, but is not limited to, generating at least one tag for each received multimedia content element, saving the received elements and their associated tags in the data warehouse 150 and/or the user device 120, and searching for multimedia elements using the assigned tags responsive of an input query. The tag is a textual index term assigned to certain content and typically comprises at least one or two words.

Specifically, according to the disclosed embodiments, the server 130 is configured to receive multimedia content elements from the user device 120, via the network 110, accompanied by a request to tag the elements. With this aim, the server 130 sends each received multimedia content element to the SGS 140 and/or DCC system 160. The decision as to which of the SGS 140 and/or DCC system 160 to be used may be a default configuration or determined by the nature of the query.

In an embodiment, the SGS 140 receives a multimedia content element and returns at least one signature respective thereto. The generated signature(s) may be robust to noise and distortions. The process for generating the signatures is discussed in detail below.

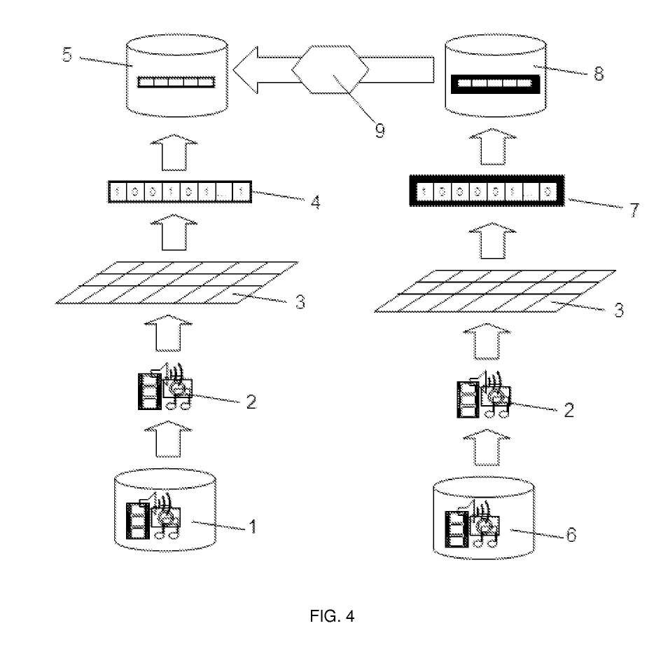

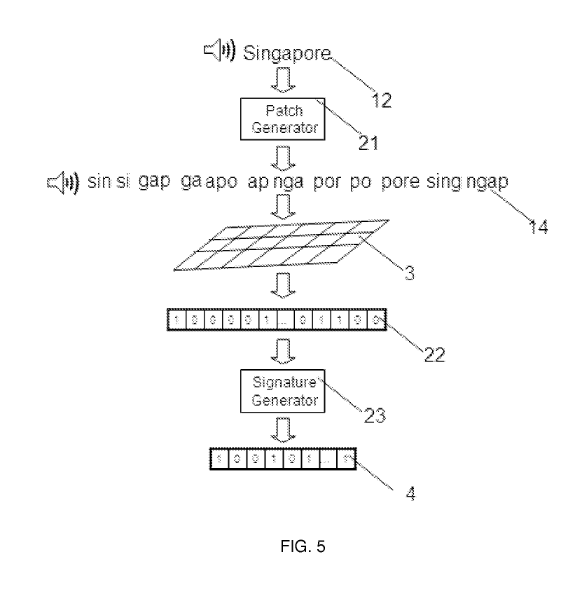

Then, using the generated signature(s), the server 130 is configured to search for similar multimedia content elements in the data warehouse 150. The process of matching between multimedia content elements is discussed in detail below with respect to FIGS. 4 and 5.

Upon identification of similar multimedia content elements, the server 130 is configured to extract tags associated with the identified elements and assigned such tags to the received multimedia content elements. It should be noted that if multiple tags are found matching, the server 130 may correlate between the tags or select tags that are most descriptive or strongly related to the received element. Such determination may be achieved by selecting tags associated with multimedia content elements such that their respective signatures match the input element over a predefined threshold. The preconfigured threshold level may be configured based on, for example, the sensitivity of the detection. For example, a lower threshold value may be set for a security application than would be set for an entertainment application.

According to another embodiment, the tag for a received multimedia content element is determined based on a concept structure (or concept). A concept is a collection of signatures representing elements of the unstructured data and metadata describing the concept. As a non-limiting example, a ‘Superman concept’ is a signature-reduced cluster of signatures describing elements (such as multimedia elements) related to, e.g., a Superman cartoon: a set of metadata representing proving textual representation of the Superman concept. Techniques for generating concept structures are also described in U.S. Pat. No. 8,266,185 (hereinafter '185) to Raichelgauz et al., which is assigned to common assignee, and is incorporated hereby by reference for all that it contains.

According to this embodiment, a query is sent to the DCC system 160 to match a received content element of at least one concept structure. If such a match is found, then the metadata of the concept structure is used to tag the received content element. The identification of a concept matching the received multimedia content element includes matching at least one signature generated for the received element (such signature(s) may be produced either by the SGS 140 or the DCC system 160) and comparing the element's signatures to signatures representing a concept structure. The matching can be performed across all concept structures maintained by the system DCC 160.

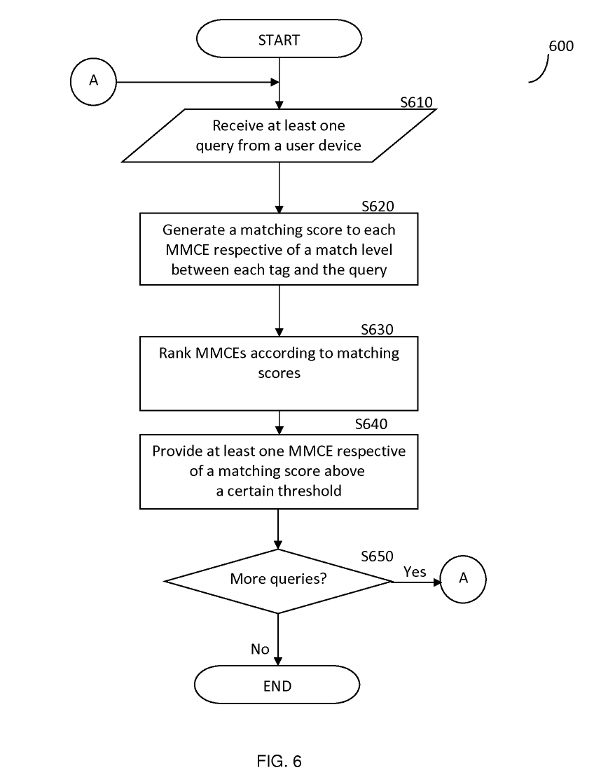

It should be noted that if the query sent to the DCC system 160 returns multiple concept structures, the server 130 is configured to rank matching concept structures to generate a tag that best describes the element. The ranking can be achieved by identifying a ratio between signatures' sizes, a spatial location of each signature, and using the probabilistic models. The process of ranking multimedia content elements is discussed in detail below with respect to FIG. 6.

The one or more tags are assigned to each of the ranked multimedia content elements returned to the user device 120. In addition, the server 130 may save each of the received elements and their respective tags in the storage device. As a non-limiting example, if the multimedia content element received is a picture in which a dog, a human and a ball are shown, signatures are generated respective of these objects (i.e., the dog, the human, and the ball). Based on the signatures, one or more tags are generated by the server 130 and assigned to the multimedia content element. Because the tag is generated respective of the contents of the picture, the tags may be “dog lovers”, “man plays with his dog”, a similarly descriptive tag.

In another embodiment, the multimedia content elements can be searched using the generated tags, either locally in the user device 120 or remotely in the data warehouse 150. Upon receiving a query or a portion thereof from a user, the search returns one or more multimedia content elements ranked respective of the correlation of the query and the elements' tags. It should be noted that when a local search is performed, for example, by means of the application 125, no connection to the network 110 is required.

It should further be noted that the signatures generated for multimedia content elements would enable accurate tagging of the elements, because the signatures generated for the multimedia content elements, according to the disclosed embodiments, allow for recognition and classification of multimedia content.

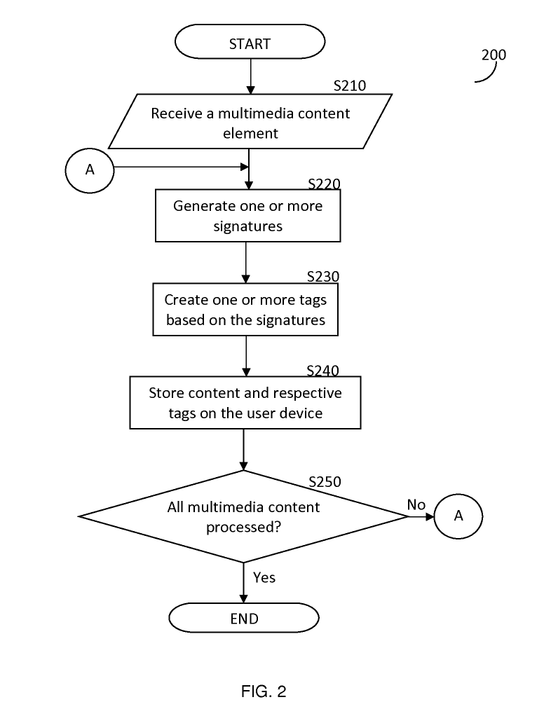

FIG. 2 depicts an exemplary and non-limiting flowchart 200 describing a method for tagging multimedia content elements. In S210, at least one multimedia content element is received.

In S220, at least one signature is generated for the multimedia content element. The signature(s) are generated by a signature generator (e.g., SGS 140) as described below with respect to FIGS. 4 and 5.

In S230, at least one tag is created and assigned to the received multimedia content element based on generated signatures. According to one embodiment, S230 includes searching for at least one matching multimedia content element in the data warehouse 150 and using the tag of the matching multimedia content element to tag the received multimedia content element. Two elements are determined to be matching if their respective signatures at least partially match (e.g., in comparison to a predefined threshold). According to another embodiment, S230 includes querying a DCC system 160 with the generated signature to identify at least one matching concept structure. The metadata of the matching concept structure is used to tag the received multimedia content element.

In S240, the multimedia content element together with its respective tags is sent to the user device 120 to be stored locally on the user device 120. In addition, multimedia content element together with its respective tag(s) may be saved in a data warehouse (e.g., warehouse 150). In S250, it is checked whether all received multimedia content elements have been processed, and if not, execution continues with S220 where a new element is selected for processing; otherwise, execution terminates.

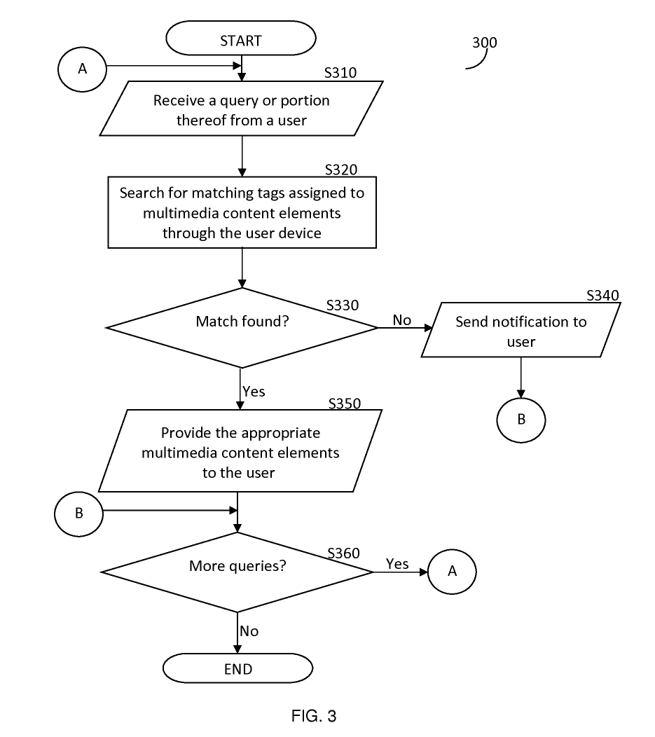

FIG. 3 depicts an exemplary and non-limiting flowchart 300 describing a method for enhancing a user search experience through a user device 120. In S310, a search query or a portion thereof is received by a user of a user device, for example, the user device 120. According to one embodiment, when the user device 120 is online in communication with the server 130, upon entering at least a portion of a query, the server 130 is configured to extract one or more suggested queries from the data warehouse 150 and provide them to the user device 120.

In S320, based on the query, a search is performed for appropriate multimedia content elements through the user device 120 based on a correlation between their assigned tags and the multimedia content elements. In S330, it is checked whether at least one matching tag is identified, and if so execution continues with S350; otherwise, execution continues with S340 where a notification is sent to the user device that no matching tags were identified. Then execution continues to S360.

In S350, respective of the matching tags the appropriate multimedia content elements are displayed in the user device 120 as search results. In S360, it is checked whether there are additional queries and if so, execution continues with S310; otherwise, execution terminates.

FIGS. 4 and 5 illustrate the generation of signatures for the multimedia content elements by the SGS 140 according to one embodiment. An exemplary high-level description of the process for large scale matching is depicted in FIG. 4. In this example, the matching is for a video content.

Video content segments 2 from a Master database (DB) 6 and a Target DB 1 are processed in parallel by a large number of independent computational cores 3 that constitute an architecture for generating the Signatures (hereinafter the “Architecture”). Further details on the computational cores generation are provided below. The independent Cores 3 generate a database of Robust Signatures and Signatures 4 for Target content-segments 5 and a database of Robust Signatures and Signatures 7 for Master content-segments 8. An exemplary and non-limiting process of signature generation for an audio component is shown in detail in FIG. 4. Finally, Target Robust Signatures and/or Signatures 4 are effectively matched, by a matching algorithm 9, to Master Robust Signatures and/or Signatures database 7 to find all matches between the two databases.

To demonstrate an example of the signature generation process, it is assumed, merely for the sake of simplicity and without limitation on the generality of the disclosed embodiments, that the signatures are based on a single frame, leading to certain simplification of the computational cores generation. The Matching System is extensible for signatures generation capturing the dynamics in-between the frames. In an embodiment the server 130 is configured with a plurality of computational cores to perform matching between signatures.

The Signatures' generation process is now described with reference to FIG. 5. The first step in the process of signatures generation from a given speech-segment is to breakdown the speech-segment to K patches 14 of random length P and random position within the speech segment 12. The breakdown is performed by the patch generator component 21. The value of the number of patches K, random length P and random position parameters is determined based on optimization, considering the tradeoff between accuracy rate and the number of fast matches required in the flow process of the server 130 and SGS 140. Thereafter, all the K patches are injected in parallel into all computational Cores 3 to generate K response vectors 22, which are fed into a signature generator system 23 to produce a database of Robust Signatures and Signatures 4.

In order to generate Robust Signatures, i.e., Signatures that are robust to additive noise L (where L is an integer equal to or greater than 1) by the computational Cores 3 a frame ‘i’ is injected into all the Cores 3. Then, Cores 3 generate two binary response vectors: \vec{S} which is a Signature vector, and \vec{RS} which is a Robust Signature vector.

For generation of signatures robust to additive noise, such as White-Gaussian-Noise, scratch, etc., but not robust to distortions, such as crop, shift and rotation, etc., a core Ci={nᵢ} (1≦i≦L) may consist of a single leaky integrate-to-threshold unit (LTU) node or more nodes. The node nᵢ equations are:

$${V}_{i} = {{Σ}_{j}}_{ij} {k}_{j}$$

$${n}_{i} = ( Vi - {Th}_{x} )$$

where, is a Heaviside step function; wᵢⱼ is a coupling node unit (CNU) between node i and image component j (for example, grayscale value of a certain pixel j); kj is an image component ‘j’ (for example, grayscale value of a certain pixel j); Thₓ is a constant Threshold value, where ‘x’ is ‘S’ for Signature and ‘RS’ for Robust Signature; and Vi is a Coupling Node Value.

The Threshold values Thₓ are set differently for Signature generation and for Robust Signature generation. For example, for a certain distribution of Vi values (for the set of nodes), the thresholds for Signature (Th_{S}) and Robust Signature (Th_{RS}) are set apart, after optimization, according to at least one or more of the following criteria:
1:

For: Vᵢ>Th_{RS}1−p(V>Th_{S})−1−(1−ε)^{l}<<1

i.e., given that l nodes (cores) constitute a Robust Signature of a certain image I, the probability that not all of these I nodes will belong to the Signature of same, but noisy image, Ĩ is sufficiently low (according to a system's specified accuracy).
2:

p(Vᵢ>Th_{RS})≈l/L

i.e., approximately l out of the total L nodes can be found to generate a Robust Signature according to the above definition.
3: Both Robust Signature and Signature are generated for certain frame i.

It should be understood that the generation of a signature is unidirectional, and typically yields lossless compression, where the characteristics of the compressed data are maintained but the uncompressed data cannot be reconstructed. Therefore, a signature can be used for the purpose of comparison to another signature without the need of comparison to the original data. The detailed description of the Signature generation can be found in U.S. Pat. Nos. 8,326,775 and 8,312,031, assigned to common assignee, which are hereby incorporated by reference for all the useful information they contain.

A computational core generation is a process of definition, selection, and tuning of the parameters of the cores for a certain realization in a specific system and application. The process is based on several design considerations, such as:
(a) The cores should be designed so as to obtain maximal independence, i.e., the projection from a signal space should generate a maximal pair-wise distance between any two cores' projections into a high-dimensional space.
(b) The cores should be optimally designed for the type of signals, i.e., the cores should be maximally sensitive to the spatio-temporal structure of the injected signal, for example, and in particular, sensitive to local correlations in time and space. Thus, in some cases a core represents a dynamic system, such as in state space, phase space, edge of chaos, etc., which is uniquely used herein to exploit their maximal computational power.
(c) The cores should be optimally designed with regard to invariance to a set of signal distortions, of interest in relevant applications.

A detailed description of the computational core generation and the process for configuring such cores is discussed in more detail in U.S. Pat. No. 8,655,801, which is assigned to a common owner.

FIG. 6 depicts an exemplary and non-limiting flowchart 600 describing a method for ranking tagged multimedia content elements respective of a match to a query received from a user device 120 according to an embodiment.

In S610, the method starts when at least one query or a portion thereof is received from a user device, for example, the user device 120. According to one embodiment, when the user device 120 is online in communication with the server 130, upon entering at least a portion of a query, the server 130 is configured to extract one or more suggested queries from the data warehouse 150 and provide them to the user device 120.

In S620, a matching score is generated by the server 130 for each tagged multimedia content element (MMCE) existing in the data warehouse 150. The matching score is generated respective of a match level between each of the tags assigned to each multimedia content element and the at least one query. The more similar a tag is to a query the higher the matching score becomes. The matching can be based on the textual matching between the tags and the input query. For example, of the tag is “fun day in NYC” and the query is “fun day in NYC” than there is a 100% match, if the input is NYC than a match of 30% is detected. In an embodiment, the matching between the query and tag is based on signatures generated for the queries and tags. It should be noted that the input query may be an image.

It should be noted that in a case where several queries are provided, a matching score respective of each query is generated. According to another embodiment, a general score may be generated respective of the matching scores generated to each query. Such a general score may be, for example, as a sum or a weighted sum of the matching scores.

In S630, the tagged multimedia content elements are ranked according the generated matching scores. Higher matching score result in a higher ranking of the tagged multimedia content elements.

In S640, at least one multimedia content element is provided to the user of the user device 120 respective of a ranking above a certain threshold. This threshold is established as a function of the matching between tags of multimedia content elements. The higher the established threshold the more specific the match will become. In an embodiment, only the highest ranked multimedia content element is sent to the user. In another embodiment, a preconfigured number of multimedia content elements ranked above the threshold are selected to be provided to the user.

In S650, it is checked whether there are additional queries and if so, execution continues with S610; otherwise, execution terminates.

As an example, a publisher wishes to find a certain image which will leave a certain impression on viewers at the ages of 13-16. For that purpose, the publisher may user the queries “popular”, “pop”, “music” and “teenagers”. Respective of the queries two images stored in the data warehouse are provided: one of the performer Madonna signing on a stage, and another one is a provocative image of Madonna taken from a film. The image of Madonna singing may have a tag of “popular pop music” and therefore have a higher matching score for the queries “popular”, “pop” and “music”, but a lower matching score for the query “teenagers”. The provocative image of Madonna taken from a film may have a tag of “movie image for teenagers” and therefore have a lower matching score for the queries “popular”, “pop” and “music”, but a higher matching score for the query “teenagers.” Therefore, the image of Madonna singing on stage shall be ranked higher for the queries “popular”, “pop” and “music and the provocative image of Madonna taken from a film will be ranked higher for the query “teenagers.”

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the disclosed embodiments and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for ranking and providing at least one multimedia content element respective of a query, comprising:
receiving at least one query from a user device;
generating a matching score for each tagged multimedia content element stored in a data warehouse respective of a match level to the at least one query;
ranking each multimedia content element based on its respective matching score; and
returning at least one multimedia content element to the user device respective of the ranking.

2. The method of claim 1, further comprising:
returning a predefined number of multimedia content elements having the highest rank.

3. The method of claim 1, further comprising:
generating at least one signature for each multimedia content element stored in the data warehouse;
generating at least one tag respective of the at least one generated signature, wherein the tag comprises one or more words.

4. The method of claim 3, wherein the at least one signature is robust to noise and distortions.

5. The method of claim 4, wherein a metadata of a matching concept structure is used to tag the multimedia content element.

6. The method of claim 1, wherein generating the matching score for each tagged multimedia content element further comprises:
textual matching each tag associated with a multimedia content element; and
assigning the matching score as the function of the textual matching.

7. The method of claim 1, wherein generating the matching score for each tagged multimedia content element further comprises:
generating at least one signature for the input query;
generating at least one signature for each tag associated with a multimedia content element;
comparing the generated signatures; and
assigning the matching score based on the matching between the generated signature.

8. The method of claim 1, wherein the matching score is assigned as a function of an overlap between the generated signatures.

9. The method of claim 1, wherein the multimedia content element is at least one of: an image, graphics, a video stream, a video clip, an audio stream, an audio clip, a video frame, a photograph, images of signals, and portions thereof.

10. A non-transitory computer readable medium having stored thereon instructions for causing one or more processing units to execute the method according to claim 1.

11. A system for ranking and providing one or more multimedia content elements respective of a query, comprising:
a processing system;
a memory connected to the processing system, the memory containing instructions that when executed by the processing system, configure the system to:
receive at least one query from a user device;
generate a matching score for each tagged multimedia content element stored in a data warehouse respective of a match level to the at least one query;
rank each multimedia content element based its respective matching score; and
return at least one multimedia content element to the user device respective of the ranking.

12. The system of claim 11, wherein the system is further configured to:
return a predefined number of multimedia content elements having the highest rank.

13. The system of claim 11, wherein the system is further configured to:
generate at least one signature for each multimedia content element stored in the data warehouse;
generate at least one tag respective of the at least one generated signature, wherein the tag comprises one or more words.

14. The system of claim 13, wherein the at least one signature is robust to noise and distortions.

15. The system of claim 14, wherein a metadata of a matching concept structure is used to tag the multimedia content element.

16. The system of claim 11, wherein the system is further configured to: textual match each tag associated with a multimedia content element; and
assign the matching score as the function of the textual matching.

17. The system of claim 11, wherein the system is further configured to: generate at least one signature for the input query;
generate at least one signature for each tag associated with a multimedia content element;
compare the generated signatures; and
assign the matching score based on the matching between the generated signature.

18. The system of claim 11, wherein the matching score is assigned as a function of an overlap between the generated signatures.

19. The system of claim 11, wherein the multimedia content element is at least one of: an image, graphics, a video stream, a video clip, an audio stream, an audio clip, a video frame, a photograph, images of signals, and portions thereof.
